(19) United States
(12) Patent Application Publication
(10) Pub. No.: US 2025/0104382 A1
(43) Pub. Date: Mar. 27, 2025

(54) SYSTEM AND METHOD FOR LOCATING A REGION OF INTEREST IN AN IMAGE CAPTURED BY A MOVEABLE CAMERA

(71) Applicant: VALERANN LTD., Tel Aviv (IL)

(72) Inventors: Tom LADYMAN, London (GB); Kelvin TSZ HEI CHOI, London (GB); Ran KATZIR, London (GB)

(73) Assignee: VALERANN LTD., Tel Aviv (IL)

(21) Appl. No.: 18/895,518

(22) Filed: Sep. 25, 2024

Related U.S. Application Data
(60) Provisional application No. 63/585,247, filed on Sep. 26, 2023.

(51) Int. Cl. G06V 10/25; G06T 5/77; G06T 7/10; G06T 7/20; G06V 10/10; G06V 10/46; G06V 20/54; G06V 20/70

(52) U.S. Cl. CPC G06V 10/25; G06T 5/77; G06T 7/10; G06T 7/20; G06V 10/16; G06V 10/462; G06V 20/54; G06V 20/70; G06V 2201/07

(57) ABSTRACT

A system and method for locating a region of interest on an image captured by a camera including: in a preparation stage: stitching a plurality of images from multiple viewpoints of the camera into a panorama of surroundings of the camera, generating a mask indicative of the location of the region of interest in the panorama; and during runtime: generating a transformation between the panorama and the captured image; and applying the transformation to the mask to get the location of the region of interest in the captured image.

### CROSS-REFERENCE TO RELATED APPLICATIONS

This application claims the benefit of U.S. Provisional Application Ser. No. 63/585,247, filed Sep. 26, 2023, which is hereby incorporated by reference in its entirety.

### FIELD OF THE INVENTION

The present invention relates generally to automatically locating regions of interest across the changing viewpoints of moveable cameras in real time.

### BACKGROUND OF THE INVENTION

Some security, surveillance or traffic cameras may be stationary, while others, such as the pan tilt zoom (PTZ) cameras, may pan and tilt and enable zooming in and out to provide wide-area coverage. Finding and labeling regions of interest (ROIs) in the images captured by the camera may provide an initial step of processing information in the image. However, locating regions of interest may present a challenge as cameras may rotate, pan zoom in or zoom out intentionally, in the case of PTZ enabled cameras, or move unintentionally, for example due to wind gusts.

Traffic cameras may be installed along roads such as highways, freeways, expressways and arterial roads, or next to sidewalks and rail and may provide live video in real-time to a control center. The live video provided by traffic cameras may enable providing a variety of intelligent transportation system (ITS) traffic management applications.

### SUMMARY OF THE INVENTION

A computer-based system and method for locating a region of interest on an image captured by a camera may include: in a preparation stage: generating a mask indicative of the location of the region of interest in a panorama of surroundings of the camera; and during runtime: generating a transformation between the panorama and the captured image; and applying the transformation to the mask to get the location of the region of interest in the captured image.

Embodiments of the invention may include generating the panorama by stitching a plurality of images from multiple viewpoints of the camera into a panorama.

Embodiments of the invention may include generating a plurality of panoramas, each for a different visibility condition.

Embodiments of the invention may include presenting the captured image on a display, wherein the presentation may include a marking of the location of the region of interest in the captured image.

Embodiments of the invention may include removing areas from the plurality of images that include presentation of metadata in the plurality of images and in-filling the removed areas in the panorama.

According to embodiments of the invention, the transformation between the panorama and the captured image includes a homography between the panorama and the captured image.

According to embodiments of the invention, the transformation is generated using a method selected from the list consisting of: random sample consensus (Ransac), scale-invariant feature transform (SIFT), nearest neighbor matching and LoFTR.

Embodiments of the invention may include generating a new transformation after the camera moves.

Embodiments of the invention may include detecting movement of the camera by detecting a change in pan, tilt or zoom values of the camera; or using a computer vision flow-based model to detect significant movement vectors in a video stream captured by the camera.

Embodiments of the invention may include activating object detection schemes selectively for detecting objects included in the region of interest and not detecting objects outside of the region of interest.

Embodiments of the invention may include labeling the region of interest and associating objects detected within the region of interest with the label of the region of interest.

Embodiments of the invention may include associating pixels in the panorama with latitude and longitude coordinates; and associating a detected object with latitude and longitude coordinates of the pixels that include the detected object.

Embodiments of the invention may include comparing the latitude and longitude coordinates of the detected object in at least two time-spaced images to measure the speed of the detected object.

Embodiments of the invention may include actively changing viewpoints of the camera and capturing an image at each of the multiple viewpoints to get the plurality of images from the multiple viewpoints.

According to embodiments of the invention, the camera may be a roadside camera.

A computer-based system and method for locating a region of interest may include: stitching a plurality of images from multiple viewpoints of a camera into a panorama generating a mask indicative of the location of the region of interest in a panorama of surroundings of the camera; detecting that the camera has moved to a first viewpoint; generating a transformation between the panorama and an image captured in the first viewpoint; and applying the transformation to the mask to get the location of the region of interest in images captured with the first viewpoint.

### BRIEF DESCRIPTION OF THE DRAWINGS

Non-limiting examples of embodiments of the disclosure are described below with reference to figures listed below. The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanying drawings.

FIG. 1 schematically illustrates a system for locating a region of interest on an image captured by a camera, according to some embodiments of the invention.

FIG. 2A presents a first image taken by a road camera from a first viewpoint, helpful in explaining embodiments of the invention.

FIG. 2B presents a second image taken by a road camera from a second viewpoint, helpful in explaining embodiments of the invention.

FIG. 2C presents a third image taken by a road camera from a third viewpoint, helpful in explaining embodiments of the invention.

FIG. 2D presents a fourth image taken by a road camera from a fourth viewpoint, helpful in explaining embodiments of the invention.

FIG. 3 presents a panorama generated from FIGS. 2A-2D, according to embodiments of the invention.

FIG. 4 presents a mask for marking a region of interest on a panorama, according to embodiments of the invention.

FIG. 5 presents a transformation between a panorama and a captured image, according to embodiments of the invention.

FIG. 6 presents a version of a captured image in which the location of a region of interest is marked, according to embodiments of the invention.

FIG. 7 shows a flowchart of a method for locating a region of interest on an image captured by a camera, according to some embodiments of the invention.

FIG. 8 shows a high-level block diagram of an exemplary computing device, according to some embodiments of the invention.

It will be appreciated that, for simplicity and clarity of illustration, elements shown in the figures have not necessarily been drawn accurately or to scale. For example, the dimensions of some of the elements may be exaggerated relative to other elements for clarity, or several physical components may be included in one functional block or element. Reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

A security, surveillance or traffic camera may include a video camera that may capture outside or indoor scenery, including people, buildings, streets, roads, railways, and vehicular, pedestrian or rail trains traffic, etc. The camera may include closed-circuit television camera, CCTV camera, automatic number plate recognition (ANPR) camera, Internet protocol (IP) camera, pan tilt zoom (PTZ) camera, pan camera, tilt camera, zoom camera, panoramic camera, infra-red camera, analog camera, artificial intelligence (AI) camera, e.g., a camera that includes internal capabilities for video analytics, etc. Some security, surveillance or traffic cameras may be stationary, while others, such as the PTZ cameras, may pan and tilt and enable zooming in and out to provide wide-area coverage.

Traffic cameras may be installed along roads such as highways, freeways, expressways and arterial roads, or next to sidewalks and rail, while security and surveillance cameras may be installed just about anywhere, in indoor and outdoor locations. Security, surveillance or traffic cameras may provide live video in real-time to a control center. The live video provided by security, surveillance or traffic cameras may enable providing a variety of applications, including, for example, ITS traffic management applications. However, to derive meaningful information from computer vision algorithms, regions of interest in the images provided by the cameras should be located, identified and labeled, and an understanding of the real-world assets represented in different areas in the image should be established. Thus, real-world assets including, for example, streets, buildings, drivable and non-drivable areas, roads, lanes, hard shoulders, car parks, slip roads, bridges, bus stops, toll booths, etc. should be located, identified and marked on the image. This presents a challenge, as cameras may be moveable (intentionally or unintentionally) and may rotate, pan zoom in or zoom out intentionally, in the case of PTZ enabled cameras, and/or move unintentionally, for example due to wind gusts. Thus, even if regions of interest were located, identified and labeled in an image at a certain time, there is a need to update the location of these regions of interest when the cameras change their viewpoint. For PTZ-enabled cameras, having access to live orientation values is often challenging due to technical and cybersecurity reasons, or in case they are operated and controlled by a third-party. Even if these values are accessible, they may not be well calibrated to the precision necessary for computer vision algorithms. As such, there is a need for an algorithm to perform location and identification of regions of interest that does not assume access to information related to the camera's orientation.

Naïve approaches for locating regions of interest on images captured by a moveable camera may include using presets, where the presets provide locations of regions of interest in some viewpoints of the movable camera. This method is problematic since locating the regions of interest is only possible in specific orientations or viewpoints of the camera, e.g., only the orientations or viewpoints for which presets were prepared are supported. Additionally, selecting the right preset for a specific viewpoint requires knowing the PTZ location values, which as discussed above, are not always available. Presents also do not support unintentional movements of the camera, and movements in directions or to locations not known in advance, and not planned for.

Another option is to use a calibration model to transform the regions of interest. When the camera moves and changes its viewpoint, the PTZ scaling is estimated using a calibration process, and the regions of interest are mapped to the new viewpoint by warping them using this calibration. This method suffers from many disadvantages, it requires the PTZ location values of the camera which are not always available, the calibration process is difficult and computationally intensive, the algorithm assumes that the viewpoint is planar (e.g. bridges cannot be masked) and despite its complexity it provides poor result as the mapping of regions of interest is not accurate, e.g., not accurate enough to perform lane masking, and it is not very robust to zoom due to the non-linearity of camera zoom.

Another naïve approach includes using flow-based techniques to track a region of interest from an initial viewpoint, e.g., one viewpoint is labeled and as the camera moves, the region is moved in the opposite direction. This method is again computationally intensive, assumes the viewpoint is planar, calibrations on a specific viewpoint could drift over time if not reset, and this method is not very accurate, again, not accurate enough to perform lane masking.

Embodiments of the invention may provide a system and method for locating a region of interest on an image captured by a moveable camera using a panorama. According to embodiments of the invention, a panorama including a plurality of images from multiple viewpoints of the camera may be generated, e.g., by stitching, merging or combining multiple images taken by the camera in various viewpoints, and a mask indicative of the locations of regions of interest in the panorama may be generated. During runtime, each time the camera moves and the viewpoint of the camera changes, a transformation between the panorama and the captured image may be generated, and the transformation may be applied to the mask to get the locations of the regions of interest in the captured image. Movement of the camera may be detected by detecting a change in pan tilt or zoom values of the camera, by comparing images, using a computer vision flow-based model to detect significant movement vectors in a video stream captured by the camera, or other methods. The transformation between the panorama and the captured image may include a homography between the panorama and the captured image, that may be generated using any applicable method such as random sample consensus (Ransac), scale-invariant feature transform (SIFT), nearest neighbor matching, LoFTR, etc. In some embodiments multiple panoramas may be generated, each for a different visibility condition, daytime, nighttime, rain, etc. Additionally or alternatively, multiple panoramas may be generated to provide calibration across multi-modal, non-continuous viewpoints.

In image processing, image masking may include a technique to separate or isolate areas or regions of interest in an image from the rest of the image. For example, the mask may include an array in the size of the image, in which elements that correspond to pixels included in the area or region of interest have one value and elements that correspond to pixels that are not included in the area or region of interest have a second value, e.g., the mask may be a binary image or a pixel map. If more than one region of interest is marked using a single mask, then each area may have a unique value in the mask.

Detecting regions of interest in an image after the viewpoint of the camera changes may be used for a variety of applications. For example, object detection schemes may be activated selectively for detecting objects included in a certain region of interest and not detecting objects outside of that region of interest, regions of interest may be labeled, and objects detected within the region of interest may be associated with the label of the region of interest. In some applications, pixels in the panorama may be associated with latitude and longitude coordinates, and a location of detected objects may be determined by associating the detected object with latitude and longitude coordinates of the pixels that include the detected object. When analyzing a video stream, the latitude and longitude coordinates of the detected object in at least two time-spaced images may be compared to measure the speed of the detected object.

Thus, embodiments of the invention may improve the technology of camera surveillance by enabling detection of regions of interest on an image captured by a moveable camera after the camera changes its viewpoint. Specifically, generating a transformation (e.g., a homography) between the panorama and the captured image and applying the transformation to a mask identifying a region of interest to produce, obtain or get the location of the region of interest in the captured image is relatively simple and requires lower computational power in comparison to prior art methods, while providing improved accuracy. Embodiments of the invention may be applicable even if there is no access to the PTZ location values of the camera, and in various lighting and weather conditions.

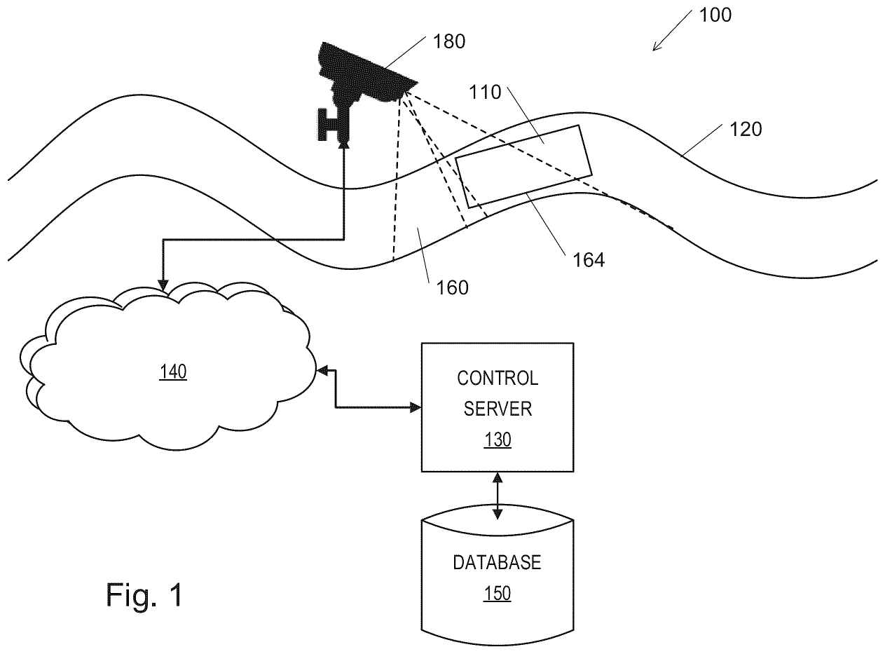

Reference is now made to FIG. 1, which schematically illustrates a system 100 for locating a region of interest on an image captured by a camera 180, according to some embodiments of the invention. According to one embodiment of the invention, system 100 may include camera 180 that may be or may include a security, surveillance or traffic camera that is connected to control server 130 over networks 140. Camera 180 may be movable, which in the context of the present application relates to a camera that is anchored or mounted to a single location, but can move intentionally or unintentionally while anchored, e.g., rotate, pan zoom in or zoom out intentionally, in the case of a PTZ enabled camera, and/or move unintentionally, for example due to wind gusts. Camera 180 may capture images of its surroundings, e.g., a real-world scene, including, for example, a road, way, path or route 120. A vehicle 110 moving along road 120, may also be captured by camera 180, depending on the location of vehicle 110 in relation to the field of view (FOV) of camera 180. As used herein, the FOV of camera 180 may refer to the area or angle that camera 180 can capture at a given moment, and the viewpoint may refer to the position of camera 180 when capturing an image, e.g., a certain viewpoint of camera 180 may provide an associated FOV, and changing the viewpoint of camera 180 may change the FOV. The total FOV may refer to the total area or angle that camera 180 can capture, when fully utilizing the range of motion and zoom options of camera 180. For example, in a first viewpoint (e.g., a first TPZ setting), camera 180 may have a first FOV 160 including a first part of road 120, and in a second viewpoint (e.g., in a second TPZ setting), camera 180 may have a second FOV 164 including a second part of road 120 as well as vehicle 110. Camera 180 may provide a video stream including the captured images to control server 130 over network 140. While only one camera 180 is depicted in FIG. 1, this is for demonstration purposes only, and system 100 may support any number of, e.g. tens, hundreds or more, cameras.

Camera 180 may be a PTZ camera, a pan camera, a tilt camera, a zoom camera, a CCTV camera, an ANPR camera, an IP camera, an analog camera, a panoramic camera, a thermal camera, an Al camera, etc. that may be positioned in one place to capture images of its surroundings. Camera 180 may be controlled to change its FOV, e.g., using the tilt, pan and/or zoom functionalities camera 180 may include. Camera 180 may include a wired or wireless network interface for connecting to network 140. It is noted that even cameras that are considered stationary, e.g., cameras with no pan tilt or zoom capabilities, may move unintentionally, e.g., due to wind gusts, and may also be considered movable cameras herein.

Network 140 may include any type of network or combination of networks available for supporting communication between camera 180 control server 130. Network 140 may include, for example, a wired, wireless, fiber optic, cellular, satellite or any other type of connection, a local area network (LAN), a wide area network (WAN), the Internet and intranet networks, etc.

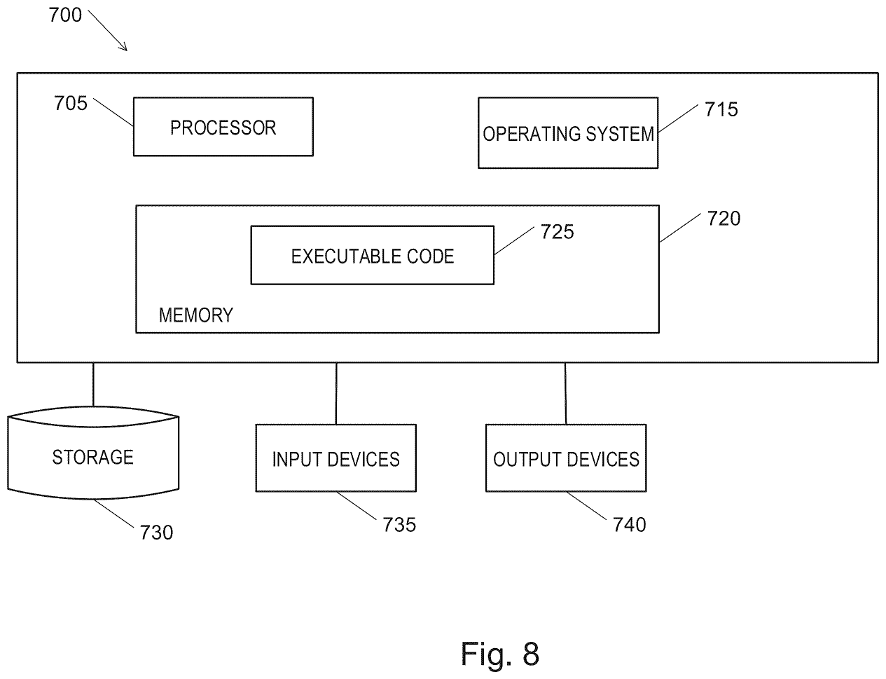

Each of control server 130 and camera 180 may be or may include a computing device, such as computing device 700 depicted in FIG. 8. One or more databases 150 may be or may include a storage device, such as storage device 730. Control server 130 and database 150 may communicate directly or over networks 140. In some embodiments, control server 130 and database 150 may be implemented in a remote location, e.g., in a ‘cloud’ computing system.

According to some embodiments of the invention, control server 130 may store in database 150 data obtained from camera 180 and other data, such as panoramas of the surrounding area of camera 180, masks, transformation parameters, and any other data as required by the application. According to some embodiments of the invention, control server 130 may be configured to obtain video streams captured by camera 180, and to locate one or more regions of interest within images of these video streams.

Control server 130 may be or may include a traffic control server of a traffic control centre or a traffic management centre (TMC), or a control server of a security or surveillance system. According to some embodiments of the invention, control server 130 may locate one or more regions of interest in an image captured by moveable camera 180. In some embodiments, control server 130 may generate or receive a panorama of the surrounding area of moveable camera 180 and generate or obtain a mask indicative of the location of the one or more regions of interest in the panorama in a preparation stage, e.g., offline. During runtime, control server 130 may locate the one or more regions of interest on images captured by moveable camera 180 by generating a transformation between the panorama and the captured images and applying the transformation to the mask to get the location of the regions of interest in the captured image.

In some embodiments, control server 130 may obtain the panorama from another service. In some embodiments, control server 130 may generate the panorama, e.g., by stitching, merging or combining multiple images taken by the camera from multiple viewpoints into a panorama. Stitching, merging or combining multiple images taken by the camera from multiple viewpoints into a panorama may be performed in any known, standard or proprietary technique.

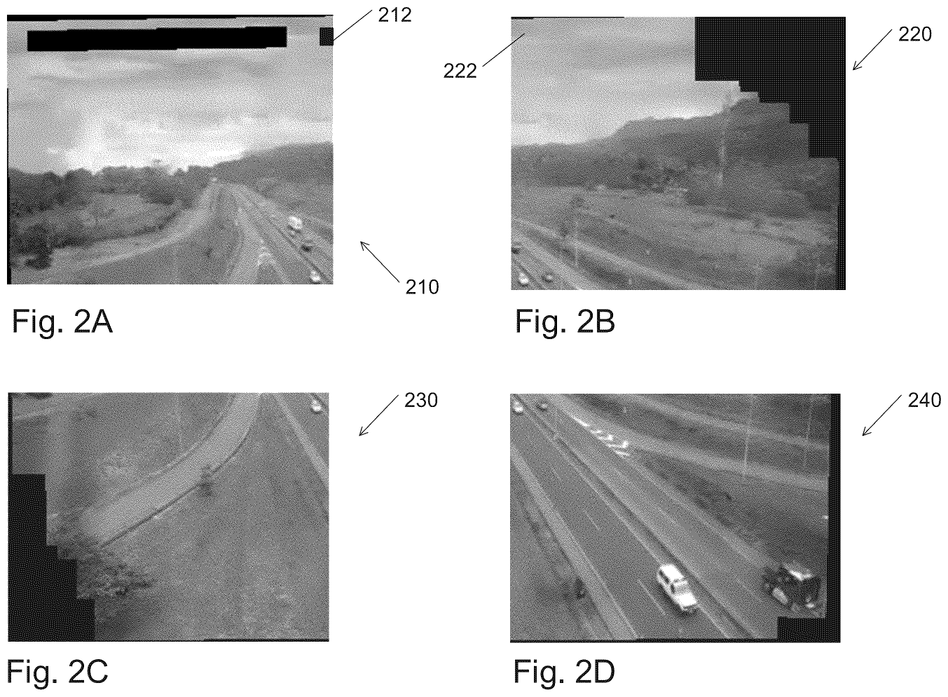

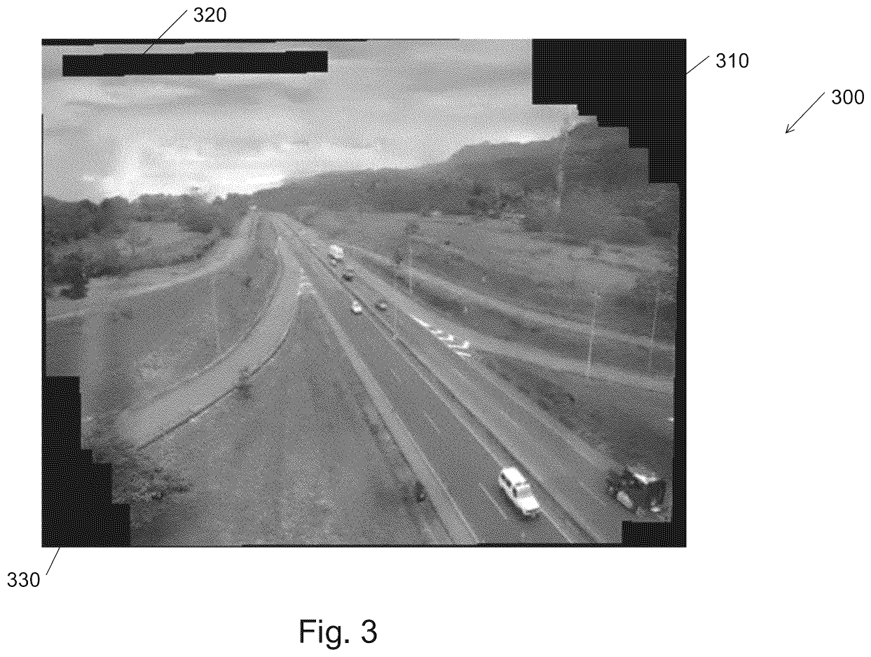

Reference is now made to FIGS. 2A-2D each presenting an image 210-240, respectively, taken by a road camera such as camera 180 from a different viewpoint, and to FIG. 3 which presents a panorama 300 generated from images 210-240, according to embodiments of the invention. Control server 130 may obtain FIGS. 2A-2D from camera 180. Panorama 300 may present the surroundings of camera 180, in a part or all of the total FOV of camera 180. In some embodiments, control server 130 may receive or generate a plurality of panoramas, each for a different visibility condition, e.g., a panorama for daytime, for nighttime, for rainy days. etc.

According to some embodiments, control server 130 may command camera 180 to change its viewpoint, e.g., by sending control signals generated by control server 130 to camera 180, and to capture images 210-240, each at one of multiple viewpoints. In some embodiments, control server 130 may not control the movements of camera 180, e.g., camera 180 may be controlled by another controller (not shown) that may not be accessible by control server 130, or camera 180 may include independent and un-cooperative PTZ movements, e.g., camera 180 may change at least one of its pan, tilt and zoom independently from control server 130. In this case, control server 130 may obtain a video stream from camera 180, and collect those images 210-240 that are taken from different viewpoints to generate panorama 300. Control server 130 may search for images with specific PTZ values or search for large image changes between images 210-240. In some embodiments, whenever camera 180 moves and changes its viewpoint to a viewpoint that is not already covered by panorama 300, control server 130 may add the image from the new viewpoint to panorama 300. Stitching new images to panorama 300 may continue until the total FOV of camera 180 is covered by panorama 300, until a sufficient part of the total FOV of camera 180 is covered by panorama 300, for a predetermined time window, e.g., one day, one week, two weeks, etc. or may continue as long as camera 180 is active. It is noted that control server 130 may add new images 210-240 to panorama 300 gradually, or collect sufficient amount of images 210-240 and then generate panorama 300. Movement of camera 180 may be detected by detecting a change in the pan tilt or zoom values of camera 180, by comparing consecutive images, or using a computer vision flow-based model to detect significant movement vectors in a video stream captured by camera 180.

Some cameras 180 may present metadata, e.g., time, location, or other metadata on images 210-240. According to embodiments of the invention, areas 212 that include presentation of metadata in images 210-240 may be removed, obscured or concealed. Those areas 212 may be in-filled in panorama 300. For example, if two images 210 and 220 that are used to create the panorama 300 overlap, and in the area of overlap one image 210 includes metadata in area 212 and the second image 220 does not include metadata in an overlapping area 222, the areas 212 presenting the metadata may be in-filled, e.g., the panorama 300 may be generated by taking area 222 from image 220 that does not include metadata.

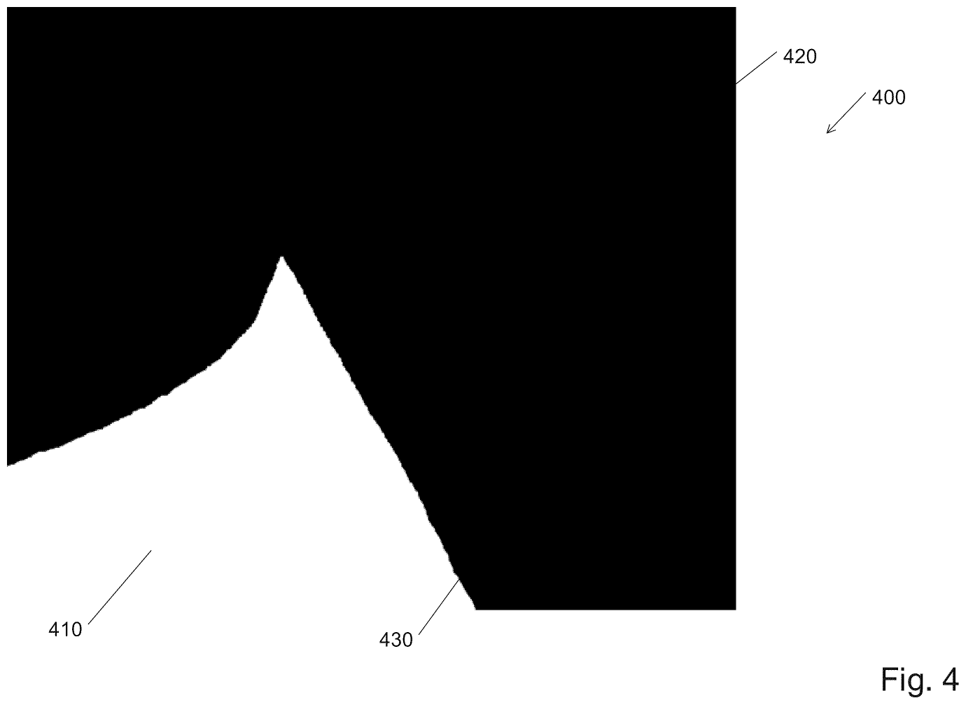

Reference is now made to FIG. 4 which presents a mask 400 for marking a region of interest 420 on panorama 300, according to embodiments of the invention. According to embodiments of the invention, control server 130 may generate mask 400 indicative of the location of the region of interest 420 in panorama 300. The region of interest 420 may be masked in panorama 300 by mask 400, and mask 400 may be stored on cloud storage, e.g., on storage 150. For example, mask 400 may include an array in the size of panorama 300, e.g., a pixel map, in which elements that correspond to pixels included in region of interest 420 have one value, e.g., represented in FIG. 4 as black, and elements that correspond remaining regions 410, e.g., to pixels that are not included in the region of interest 420, have a second value, e.g., represented in FIG. 4 as white. Thus, when designating a single area of interest, mask 400 may be a binary image. If more than one region of interest is marked using a single mask, then more than two values are used and each region may have a unique value in the mask 400.

In some embodiments, control server 130 may obtain or receive markings and labels of region of interest 420 on panorama 300 from a user. In some embodiments, various image processing and object detection tools may be used to detect and label region of interest 420 on panorama 300, or a combination of image processing tools, object detection tools and human supervision may be used to obtain or receive markings and labels of region of interest 420 on panorama 300. For example, a user, image processing and/or object detection tools may draw the line 430 separating region of interest 420 from the remaining regions 410, and label region 410 as “non-drivable area”.

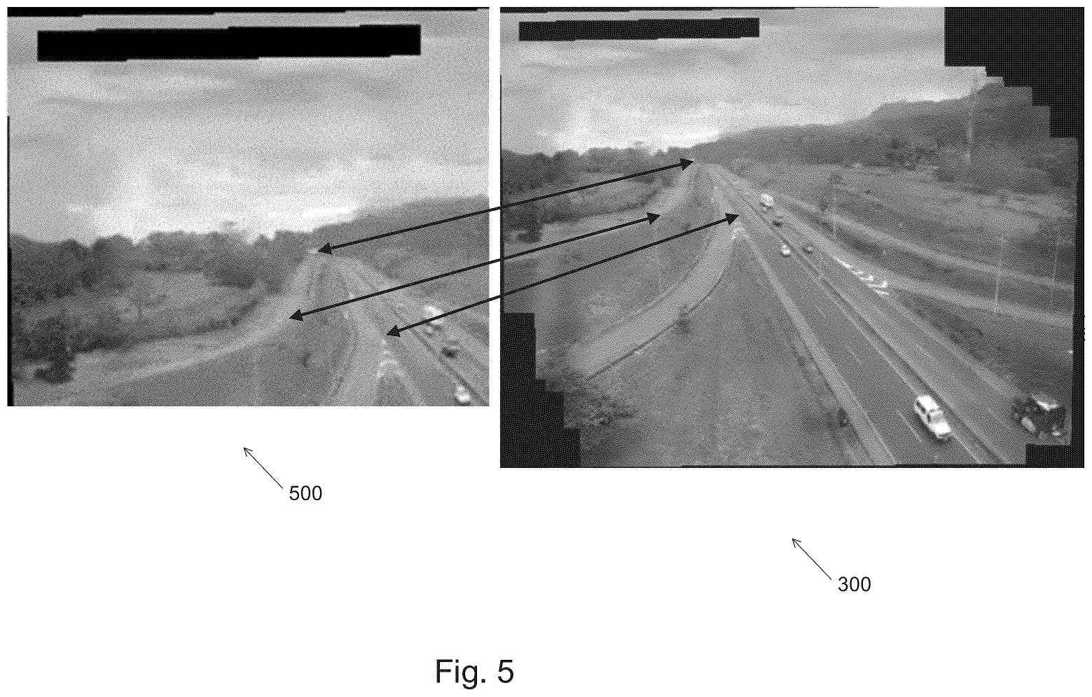

Reference is now made to FIG. 5 which presents a transformation between panorama 300 and captured image 500, according to embodiments of the invention. During runtime, camera 180 may capture images such as image 500, and control server 130 may generate a transformation between panorama 300 and image 500. The transformation between panorama 300 and captured image 500 may be or may include a homography between panorama 300 and captured image 500. A homography may include a mapping between two planes, or transformation describing the two-dimensional (2D) relationship between two images, in this case between panorama 300 and captured image 500, e.g., the homography may include the transformation of a point in panorama 300 to the location of the same point (e.g., the same real-world location) in captured image 500. The arrows in FIG. 5 present the relation between a point in panorama 300 to the location of the same point in captured image 500. The new FOV may be correlated to panorama 300 and the transformation or homography may be calculated in any applicable method, for example, using any one of Ransac, SIFT, nearest neighbor matching and LoFTR, etc.

Control server 130 may calculate a transformation or homography for a certain viewpoint of camera 180, and use it as long as camera 180 remains stationary. Once control server 130 detects that camera 180 has moved and changed its viewpoint and FOV, (e.g., from FOV 160 to FOV 164) control server 130 may calculate a new or updated transformation or homography for the new viewpoint (a new or updated transformation may be a transformation that suits or is usable for a new viewpoint instead of the previous transformation that suited or was usable for the previous viewpoint). Control server 130 may detect that camera 180 has moved by detecting a change in pan tilt or zoom values of camera 180, by comparing consecutive images, or using a computer vision flow-based model to detect significant movement vectors in a video stream captured by camera 180, or using any other applicable method.

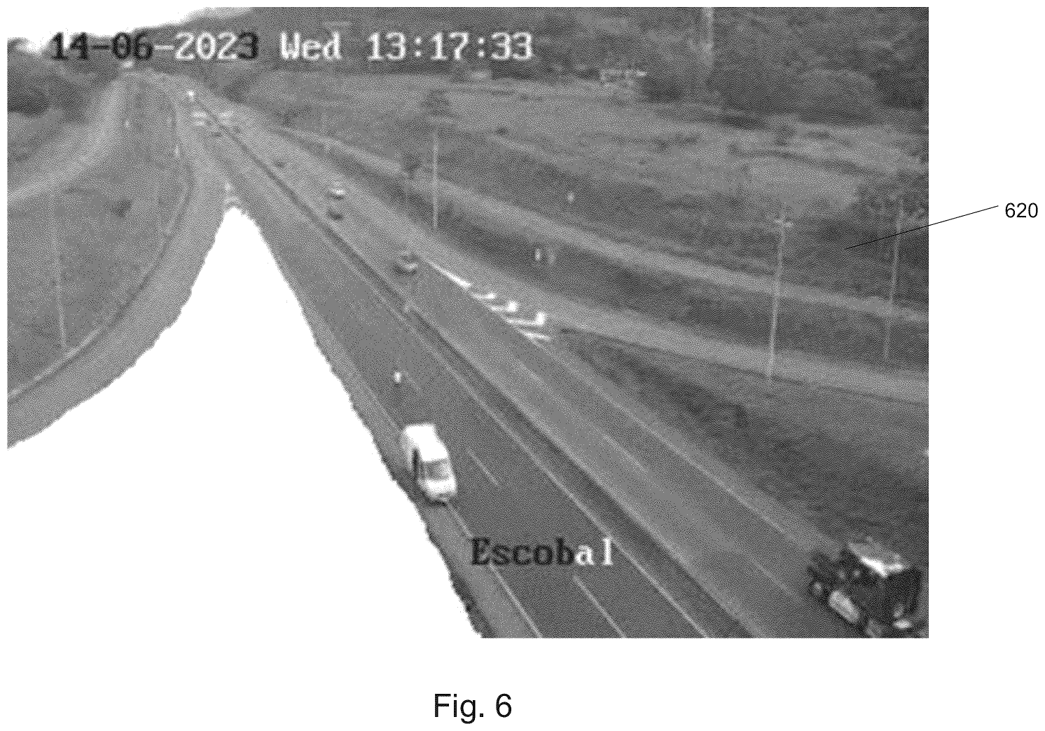

According to embodiments of the invention, control server 130 may locate region of interest 420 on captured image 500 captured by a camera 180 by applying the calculated transformation or homography to mask 400 to get the location of the region of interest 420 in captured image 500. FIG. 6 presents a version of captured image 500 in which the location of the region of interest 420 is marked, according to embodiments of the invention. The location of the region of interest has been transformed from panorama 300 to captured image 500 using the homography and is presented as region of interest 620.

Once the transformation is applied and the location of the region of interest 420 in captured image 500 is determined, control server 130 may use the location of the region of interest 420 for various purposes. For example:
Control server 130 may present captured image 500 on a display or a screen, e.g., using output devices 740, where the presentation may include a marking of the location of the region of interest 620 in captured image 500 and a label of the region of interest 620. Control server 130 may present captured image 500 to an operator in a TMC.
Control server 130 may activate or perform object detection schemes selectively for detecting objects included in the region of interest 420 and not detecting objects outside of the region of interest 420, or the other way around, e.g., control server 130 may activate object detection schemes for detecting objects outside of the region of interest 420 only. For example, if the region of interest includes (e.g., labeled as) a lane, control server 130 may activate object detection schemes within the region of interest 420, e.g., in the lane area only, and if the region of interest 420 includes (e.g., labeled as) non-drivable areas, control server 130 may activate object detection schemes outside of the region of interest 420.
Control server 130 may label the region of interest 420 and associate objects detected within the region of interest 420 with the label of the region of interest 420. For example, if the region of interest includes (e.g., labeled as) a lane, control server 130 may associate objects detected within the region of interest 420, e.g., vehicle 110, with the label “lane”.
Control server 130 may determine the real-world coordinates of detected objects by associating pixels in panorama 300 with latitude and longitude coordinates, and associating a detected object with latitude and longitude coordinates of the pixels that include the detected object.
Control server 130 may measure the speed of a detected object by comparing the latitude and longitude coordinates of the detected object in at least two time-spaced images to calculate a distance and dividing the distance by the time difference between the two images.
Control server 130 may combine the location of region of interest 420 with incident detection and an operational user interface, whereby if an incident is detected within region of interest 420 road operators can dispatch emergency services to reach and investigate the detected incident.
Control server 130 may use the correlation between panorama 300 and captured image 500 to determine a viewpoint of a traffic camera without using a geographic information system (GIS) model.

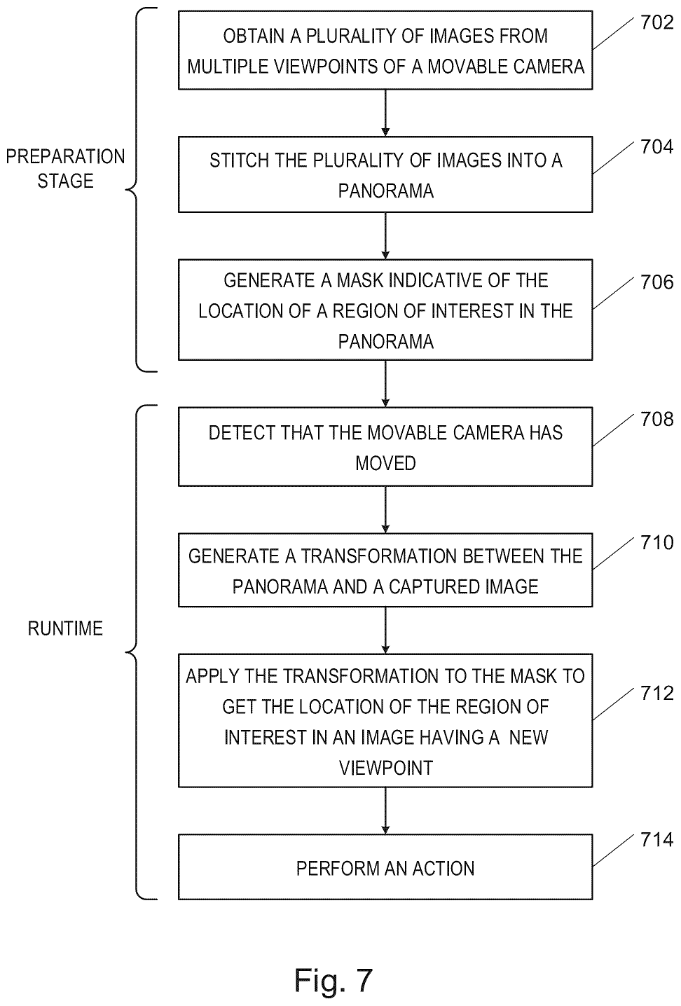

Reference is now made to FIG. 7, which is a flowchart of a method for locating a region of interest on an image captured by a camera, according to embodiments of the invention. While in some embodiments the operations of FIG. 7 are carried out using systems as shown in FIGS. 1 and/or 8, in other embodiments other systems and equipment can be used.

In operation 702, a processor (e.g., processor 705 depicted in FIG. 8, when executing code 725) may obtain or receive a plurality of images from multiple viewpoints of a camera (e.g., a movable camera or camera 180 in FIG. 1). In some embodiments, the processor may generate control signals to control the PTZ values of the camera, to obtain images in all the viewpoints required for generating the panorama. In some embodiments, the processor may not have control over the camera, and thus may collect images taken by the camera over time. In some applications, the processor may scan a database of images already captured by the camera, or wait for the camera to capture enough images from different viewpoints. The collected images may cover the total FOV of the camera, or just a part of the total FOV of the camera.

In operation 704, the processor may stitch, combine or merge the plurality of images into a panorama, using any applicable method. In cases where some of the plurality of images overlap, the overlapping section in the panorama may be taken from the image providing a better quality of the overlapping section. For example, if in one of the overlapping images the overlapped section includes presentation of metadata on the image, and that overlapped section is clearly presented in a second image, the overlapping section may be imported to the panorama from the second image.

In operation 706, the processor may generate a mask indicative of the location of a region of interest in the panorama. The mask may include an array or a pixel map, having the same dimensions as the panorama, where each element in the array corresponds to a pixel in the panorama. Different values of elements in the mask may represent different regions in the panorama. For example, if a single region of interest is marked by the mask, elements in the mask that correspond to pixels that are included in the region of interest may have a first value, while elements in the mask that correspond to pixels that are not included in the region of interest may have a second value. The processor may also label the region of interest with a label that is indicative of the type of the region of interest, e.g., a building, a lane, a non-drivable area, rails, etc.

The processor may generate the mask and the label of the region of interest in the panorama based on data obtained from a user. In some embodiments, the processor may use various image processing and object detection tools to detect and label the region of interest on the panorama, or use a combination of image processing and object detection tools, and human supervision.

In operation 708, the processor may detect that the camera has moved to a new viewpoint and have a new FOV, e.g., different from what the camera had before. The change in viewpoint, e.g., the movement of the camera, may be detected by detecting a change in pan tilt or zoom values of the camera, e.g., by obtaining the PTS values from the camera or from another server controlling the camera, or by controlling those values, by comparing consecutive images, or using a computer vision flow-based model to detect significant movement vectors in a video stream captured by the camera, or using any other applicable method.

In operation 710, the processor may generate a transformation between the panorama and a captured image, e.g., an image that is captured with the new viewpoint of the camera. The transformation may provide the relationship between the panorama and the captured image. The transformation between the panorama and the captured image may include a homography between the panorama and the captured image, that may be generated using any applicable method such as Ransac, SIFT, nearest neighbor matching, LoFTR, etc.

In operation 712, the processor may apply the transformation to the mask to get the location of the region of interest in images captured with or having the new viewpoint. In operation 714, once the location of the region of interest in the image is known, the processor may perform various actions that require knowledge of the region of interest, as disclosed herein. Those actions may include presenting the captured image on a screen or a display, with a marking of the region of interest. If the region of interest is associated with a label that is indicative of the type of the region of interest, this label may be presented as well. Objects detected within the region of interest may be associated with the label of the region of interest. The processor may perform object detection schemes selectively only in the region of interest or only outside of the region of interest. Pixels in the panorama may be associated with real-world latitude and longitude coordinates, and a real-world location of detected objects may be determined by associating the detected object with latitude and longitude coordinates of the pixels that include the detected object. When analyzing a video stream, the latitude and longitude coordinates of the detected object in at least two time-spaced images may be compared to measure the speed of the detected object, etc.

It is noted that operations 702-706 may be seen as a preparation stage and may be repeated several times to generate a plurality of panoramas, each for different visibility condition, e.g., for different light intensities, rainy conditions, etc. and when an image is captured, the transformation is made in operation 710 relatively to the panorama that includes the closes visibility conditions to the captured image. Operations 708-714 may occur during runtime.

Reference is made to FIG. 8, showing a high-level block diagram of an exemplary computing device according to some embodiments of the invention. Computing device 700 may include a processor 705 that may be, for example, one or more of a central processing unit processor (CPU), a graphics processing unit (GPU), a data processing unit (DPU) or any other suitable multi-purpose or specific processors or controllers, a chip or any suitable computing or computational device, an operating system 715, a memory 120, executable code 725, a storage system 730, input devices 735 and output devices 740. Processor 705 (or one or more controllers or processors, possibly across multiple units or devices) may be configured to carry out methods described herein, and/or to execute or act as the various modules, units, etc. for example when executing code 725. More than one computing device 700 may be included in, and one or more computing devices 700 may be, or act as the components of, a system according to embodiments of the invention. Various components, computers, and modules of FIG. 1 may include devices such as computing device 700, and one or more devices such as computing device 700 may carry out functions such as those described in FIG. 7. For example, control server 130 may be implemented on or executed by a computing device 700.

Operating system 715 may be or may include any code segment (e.g., one similar to executable code 725) designed and/or configured to perform tasks involving coordination, scheduling, arbitration, controlling or otherwise managing operation of computing device 700, for example, scheduling execution of software programs or enabling software programs or other modules or units to communicate.

Memory 720 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long term memory unit, or other suitable memory or storage units. Memory 720 may be or may include a plurality of, possibly different memory units. Memory 720 may be a computer or processor non-transitory readable medium, or a computer non-transitory storage medium, e.g., a RAM. Memory 720 may be or may include a non-transitory computer-readable storage medium storing instructions, which when executed by a processor or controller, carry out methods disclosed herein.

Executable code 725 may be any executable code, e.g., an application, a program, a process, task or script. Executable code 725 may be executed by processor 705 possibly under control of operating system 715. For example, executable code 725 may configure processor 705 to locate a region of interest on an image captured by a camera, and perform other methods as described herein. Although, for the sake of clarity, a single item of executable code 725 is shown in FIG. 8, a system according to some embodiments of the invention may include a plurality of executable code segments similar to executable code 725 that may be loaded into memory 720 and cause processor 705 to carry out methods described herein.

Storage system 730 may be or may include, for example, a hard disk drive, a CD-Recordable (CD-R) drive, a Blu-ray disk (BD), a universal serial bus (USB) device or other suitable removable and/or fixed storage unit. Data such as the panoramas and masks as well as other data required for performing embodiments of the invention, may be stored in storage system 730 and may be loaded from storage system 730 into memory 720 where it may be processed by processor 705. Some of the components shown in FIG. 8 may be omitted. For example, memory 720 may be a non-volatile memory having the storage capacity of storage system 730. Accordingly, although shown as a separate component, storage system 730 may be embedded or included in memory 720.

Input devices 735 may be or may include a mouse, a keyboard, a microphone, a touch screen or pad or any suitable input device. Any suitable number of input devices may be operatively connected to computing device 700 as shown by block 735. Output devices 740 may include one or more displays or monitors, speakers and/or any other suitable output devices. Any suitable number of output devices may be operatively connected to computing device 700 as shown by block 740. Any applicable input/output (I/O) devices may be connected to computing device 700 as shown by blocks 735 and 740. For example, a wired or wireless network interface card (NIC), a printer, a universal serial bus (USB) device or external hard drive may be included in input devices 735 and/or output devices 740.

In some embodiments, device 700 may include or may be, for example, a personal computer, a desktop computer, a laptop computer, a workstation, a server computer, a network device, a smartphone or any other suitable computing device. A system as described herein may include one or more devices such as computing device 700. Device 700 or parts thereof may be implemented in a remote location, e.g., in a ‘cloud’ computing system.

When discussed herein, “a” computer processor performing functions may mean one computer processor performing the functions or multiple computer processors or modules performing the functions; for example, a process as described herein may be performed by one or more processors, possibly in different locations.

In the description and claims of the present application, each of the verbs, “comprise”, “include” and “have”, and conjugates thereof, are used to indicate that the object or objects of the verb are not necessarily a complete listing of components, elements or parts of the subject or subjects of the verb. Unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of an embodiment as described. In addition, the word “or” is considered to be the inclusive “or” rather than the exclusive or, and indicates at least one of, or any combination of items it conjoins.

Descriptions of embodiments of the invention in the present application are provided by way of example and are not intended to limit the scope of the invention. The described embodiments comprise different features, not all of which are required in all embodiments. Embodiments comprising different combinations of features noted in the described embodiments, will occur to a person having ordinary skill in the art. Some elements described with respect to one embodiment may be combined with features or elements described with respect to other embodiments. The scope of the invention is limited only by the claims.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

1. A method for locating a region of interest in an image captured by a camera, the method comprising:
in a preparation stage:
generating a mask indicative of the location of the region of interest in a panorama of surroundings of the camera; and
during runtime:
generating a transformation between the panorama and the captured image; and
applying the transformation to the mask to get the location of the region of interest in the captured image.

2. The method of claim 1, comprising generating the panorama by stitching a plurality of images from multiple viewpoints of the camera into the panorama.

3. The method of claim 1, comprising generating a plurality of panoramas, each for a different visibility condition.

4. The method of claim 1, comprising presenting the captured image on a display, wherein the presentation comprises a marking of the location of the region of interest in the captured image.

5. The method of claim 1, comprising removing areas from the plurality of images that include presentation of metadata in the plurality of images and in-filling the removed areas in the panorama.

6. The method of claim 1, wherein the transformation between the panorama and the captured image includes a homography between the panorama and the captured image.

7. The method of claim 1, wherein the transformation is generated using a method selected from the list consisting of: random sample consensus (Ransac), scale-invariant feature transform (SIFT), nearest neighbor matching and LoFTR.

8. The method of claim 1, comprising generating a new transformation after the camera moves.

9. The method of claim 7, comprising detecting movement of the camera by detecting a change in pan, tilt or zoom values of the camera; or using a computer vision flow-based model to detect significant movement vectors in a video stream captured by the camera.

10. The method of claim 1, comprising activating object detection schemes selectively for detecting objects included in the region of interest and not detecting objects outside of the region of interest.

11. The method of claim 9, comprising labeling the region of interest and associating objects detected within the region of interest with the label of the region of interest.

12. The method of claim 9, comprising:
associating pixels in the panorama with latitude and longitude coordinates; and
associating a detected object with latitude and longitude coordinates of the pixels that include the detected object.

13. The method of claim 11, comprising comparing the latitude and longitude coordinates of the detected object in at least two time-spaced images to measure the speed of the detected object.

14. The method of claim 1, comprising actively changing viewpoints of the camera and capturing an image at each of the multiple viewpoints to get the plurality of images from the multiple viewpoints.

15. The method of claim 1, wherein the camera is a roadside camera.

16. A method for locating a region of interest, the method comprising:
stitching a plurality of images from multiple viewpoints of a camera into a panorama;
generating a mask indicative of the location of the region of interest in the panorama of surroundings of the camera;
detecting that the camera has moved to a first viewpoint;
generating a transformation between the panorama and an image captured in the first viewpoint; and
applying the transformation to the mask to get the location of the region of interest in images captured with the first viewpoint.

17. A system for locating a region of interest on an image captured by a camera, the system comprising:
a memory; and
a processor configured to:
in a preparation stage:
generate a mask indicative of the location of the region of interest in a panorama of surroundings of the camera; and
during runtime:
generate a transformation between the panorama and the captured image; and
apply the transformation to the mask to get the location of the region of interest in the captured image.

18. The system of claim 17, wherein the processor is configured to generate the panorama by stitching a plurality of images from multiple viewpoints of the camera into the panorama.

19. The system of claim 17, wherein the processor is configured to generate a plurality of panoramas, each for a different visibility condition.

20. The system of claim 17, comprising a display, wherein the processor is configured to present the captured image on the display, wherein the presentation comprises a marking of the location of the region of interest in the captured image.

21. The system of claim 17, wherein the processor is configured to remove areas from the plurality of images that include presentation of metadata in the plurality of images and in-fill the removed areas in the panorama.

22. The system of claim 17, wherein the transformation between the panorama and the captured image includes a homography between the panorama and the captured image.

23. The system of claim 17, wherein the processor is configured to generate the transformation using a method selected from the list consisting of: random sample consensus (Ransac), scale-invariant feature transform (SIFT), nearest neighbor matching and LoFTR.

24. The system of claim 17, wherein the processor is configured to generate a new transformation after the camera moves.

25. The system of claim 24, wherein the processor is configured to detect movement of the camera by detecting a change in pan, tilt or zoom values of the camera; or using a computer vision flow-based model to detect significant movement vectors in a video stream captured by the camera.

26. The system of claim 17, wherein the processor is configured to activate object detection schemes selectively for detecting objects included in the region of interest and not detecting objects outside of the region of interest.

27. The system of claim 26, wherein the processor is configured to label the region of interest and associating objects detected within the region of interest with the label of the region of interest.

28. The system of claim 26, wherein the processor is configured to:
associate pixels in the panorama with latitude and longitude coordinates; and
associate a detected object with latitude and longitude coordinates of the pixels that include the detected object.

29. The system of claim 28, wherein the processor is configured to compare the latitude and longitude coordinates of the detected object in at least two time-spaced images to measure the speed of the detected object.

30. The system of claim 17. wherein the processor is configured to actively change viewpoints of the camera and capture an image at each of the multiple viewpoints to get the plurality of images from the multiple viewpoints.

31. The system of claim 17. wherein the camera is a roadside camera.
